(19) United States
(12) Patent Application Publication
(10) Pub. No.: US 2024/0007362 A1
(43) Pub. Date: Jan. 4, 2024

(54) NFV System

(71) Applicant: Nippon Telegraph and Telephone Corporation, Tokyo (JP)

(72) Inventors: Kenji Tanaka, Tokyo (JP); Yuki Arikawa, Tokyo (JP); Tsuyoshi Ito, Tokyo (JP); Tsutomu Takeya, Tokyo (JP); Takeshi Sakamoto, Tokyo (JP)

(21) Appl. No.: 18/253,508

(22) PCT Filed: Nov. 30, 2020
(86) PCT No.: PCT/JP2020/044463

§ 371 Date: May 18, 2023

(51) Int. Cl. H04L 41/40; H04L 49/90

(52) U.S. Cl. CPC H04L 41/40; H04L 49/9068

(57) ABSTRACT

In an NFV system, a protocol processor that receives a packet from an external network, a calculator that implements NFV for performing predetermined processing on the received packet, and an ANN calculator that performs processing using an ANN in the processing of the NFV are mounted on an NIC.

### CROSS-REFERENCE TO RELATED APPLICATIONS

This application is a national phase entry of PCT Application No. PCT/JP2020/044463, filed on Nov. 30, 2020, which application is hereby incorporated herein by reference.

### TECHNICAL FIELD

The present invention relates to an NFV system that implements network function virtualization.

### BACKGROUND

Middleboxes that implement a network function (NF) play an important role in the Internet today. In addition to a forwarding function provided by a router, the middlebox plays important roles such as providing a new NF in addition to security functions such as a firewall, intrusion prevention and detection, and performance improvement functions such as load balancing, a wide area network (WAN), and an optimizer.

Conventional NFs were equipped as proprietary monolithic software running on dedicated hardware. In recent years, network operators have started to move NFs from a dedicated middlebox to network function virtualization (NFV) technology that runs on commodity servers.

Since the advent of NFV, NFV has rapidly attracted attention in both academia and industry. Hundreds of industry insiders are planning or have already deployed NFV and are aiming for high elasticity of the network and reduced management costs.

As another trend to improve NF, the networking community has employed artificial neural networks (ANNs) to address the challenges that have existed in networking for many years. In particular, researchers are beginning to employ ANNs in order to implement advanced packet processing satisfying performance and security targets and implement advanced NF (see Non Patent Literature 1).

Users utilizing conventional NFs suffer from high infrastructure costs and maintenance costs, and require extensive manual work and expertise to make effective determinations. For example, in an intrusion detection system (IDS), new cyberattacks are detected on a daily basis. Therefore, operators always need to update the signature verification rule.

In addition, in order to change the traffic load, the flow size distribution, the traffic concentration degree, and the like for the purpose of load distribution of the entire network, the operators intuitively select the manually created heuristic and determine traffic optimization.

However, the operator's decision is not necessarily optimal, which can lead to a waste of bandwidth. On the other hand, ANNs are adept at learning advanced nonlinear concepts and performing optimization in a complex and uncertain environment, which can greatly reduce management and operation costs.

FIG. 8 is a block diagram illustrating a hardware configuration of a conventional NFV system. A communication unit 300 performs protocol processing on a packet input from an external network. A central processing unit 301 implements NFV for performing predetermined processing on the packet received by the communication unit 300. An NFV program is stored in the central processing unit 301. In the configuration of FIG. 8, a calculation unit 302 performs processing of an ANN with a large amount of calculation required for network operation management. The central processing unit 301 passes the packet to the communication unit 300 after all the processing on the packet is completed. The communication unit 300 transmits the packet to the transfer destination.

The communication unit 300 is implemented using a network interface card (NIC). The central processing unit 301 is implemented using a central processing unit (CPU). The calculation unit 302 is implemented using a graphic processing unit (GPU).

The NFV is required to have a low delay and a wide band, but there is a problem that a delay occurs because data is transferred between the NIC, the CPU, and the GPU. In addition, there is a problem that the processing band of the NFV is limited by the throughput of a bus in a server casing.

### CITATION LIST

### Non Patent Literature

Non Patent Literature 1: Y. Mirsky, T. Doitshman, Y. Elovici, and A. Shabtai, “Kitsune: An Ensemble of Autoencoders for Online Network Intrusion Detection”, arXiv [cs.CR], 2018, <https://arxiv.org/pdf/1802.09089.pdf>

### SUMMARY

### Technical Problem

Embodiments of the present invention have been made to solve the above problems, and an object of embodiments of the present invention is to provide an NFV system capable of reducing a delay generated in processing of NFV.

### Solution to Problem

An NFV system of a first embodiment of the present invention includes a first NIC, in which the first NIC includes: a protocol processing unit configured to receive a packet from an external network; a first calculation unit configured to implement NFV for performing predetermined processing on the received packet; and a second calculation unit configured to perform processing using an ANN in the processing of the NFV, the protocol processing unit, the first calculation unit, and the second calculation unit being mounted on the first NIC.

In addition, in a configuration example (second embodiment) of an NFV system of the present invention, the protocol processing unit, the first calculation unit, and the second calculation unit include a programmable logic device.

In addition, in a configuration example (third embodiment) of an NFV system of the present invention, a plurality of the second calculation units are provided in the first NIC, and the first NIC further includes a dispatch unit configured to monitor operating statuses of the plurality of second calculation units, divide the processing of the ANN according to the operating statuses of the second calculation units to achieve efficient processing, and allocate the processing to the plurality of second calculation units.

In addition, in a configuration example (third embodiment) of an NFV system of the present invention, the protocol processing unit, the first calculation unit, the second calculation unit, and the dispatch unit include a programmable logic device.

In addition, in a configuration example (fourth embodiment) of an NFV system of the present invention, a plurality of the first NICs are provided in a server device, the server device includes the plurality of first NICs and a shared memory, and the dispatch unit of each first NIC writes state information of the second calculation unit under control in the shared memory, determines whether or not processing of the second calculation unit in a busy state is allocatable to the second calculation unit of another first NIC on the basis of the state information recorded in the shared memory when the second calculation unit under control is in the busy state, and requests the dispatch unit of the first NIC to which the processing has been determined to be allocatable to execute the processing of the second calculation unit in the busy state.

In addition, in a configuration example (fourth embodiment) of an NFV system of the present invention, a plurality of the first NICs are provided in a server device, the protocol processing unit, the first calculation unit, the second calculation unit, and the dispatch unit of each first NIC include a programmable logic device, the server device includes the plurality of first NICs, and the dispatch unit of each first NIC writes state information of the second calculation unit under control in a memory of the programmable logic device in the same first NIC as the dispatch unit, reads state information recorded in a memory of the programmable logic device of another first NIC via a network when the second calculation unit under control is in a busy state, determines whether or not processing of the second calculation unit in the busy state is allocatable to the second calculation unit of another first NIC, and requests the dispatch unit of the first NIC to which the processing has been determined to be allocatable to execute the processing of the second calculation unit in the busy state.

In addition, in a configuration example (fifth embodiment) of an NFV system of the present invention, a plurality of the first NICs are provided in each of a plurality of server devices, each of the server devices includes the plurality of first NICs, a shared memory, and a second NIC for RDMA, the dispatch unit of each first NIC writes state information of the second calculation unit under control in the shared memory in the same server device as the dispatch unit, determines whether or not processing of the second calculation unit in a busy state is allocatable to the second calculation unit of another first NIC on the basis of the state information recorded in the shared memory when the second calculation unit under control is in the busy state, and requests the dispatch unit of the first NIC to which the processing has been determined to be allocatable to execute the processing of the second calculation unit in the busy state, and the second NIC transfers information recorded in the shared memory in the same server device as the second NIC to the shared memory of another server device.

In addition, in a configuration example (fifth embodiment) of an NFV system of the present invention, a plurality of the first NICs are provided in each of a plurality of server devices, the protocol processing unit, the first calculation unit, the second calculation unit, and the dispatch unit of each first NIC include a programmable logic device, each of the server devices includes the plurality of first NICs, and the dispatch unit of each first NIC writes state information of the second calculation unit under control in a memory of the programmable logic device in the same first NIC as the dispatch unit, reads state information recorded in a memory of the programmable logic device of another first NIC via a network when the second calculation unit under control is in a busy state, determines whether or not processing of the second calculation unit in the busy state is allocatable to the second calculation unit of another first NIC, and requests the dispatch unit of the first NIC to which the processing has been determined to be allocatable to execute the processing of the second calculation unit in the busy state.

### Advantageous Effects of Embodiments of Invention

According to embodiments of the present invention, NFV processing is performed by the first calculation unit and the second calculation unit. Since data transfer is performed in the first NIC between the protocol processing unit, the first calculation unit, and the second calculation unit, a conventional delay does not occur. In addition, the processing band of the ANN is not limited by the throughput of the bus between the CPU and the GPU as in the related art. In addition, in embodiments of the present invention, since a general-purpose OS is not used, a delay due to the OS does not occur. In embodiments of the present invention, it is possible to reduce power consumption, initial cost, and management cost by eliminating devices such as a CPU and a GPU of a conventional NFV system.

### BRIEF DESCRIPTION OF THE DRAWINGS

FIG. 1 is a block diagram illustrating a configuration of an NFV system according to a first embodiment of the present invention.

FIG. 2 is a block diagram illustrating a configuration of an NFV system according to a second embodiment of the present invention.

FIG. 3 is a block diagram illustrating a configuration of an NFV system according to a third embodiment of the present invention.

FIG. 4 is a block diagram illustrating a configuration of an NFV system according to a fourth embodiment of the present invention.

FIG. 5 is a block diagram illustrating a configuration of an NFV system according to a fifth embodiment of the present invention.

FIG. 6 is a block diagram illustrating a configuration of an NFV system according to a sixth embodiment of the present invention.

FIG. 7 is a block diagram illustrating a configuration of a conventional NFV system.

FIG. 8 is a block diagram illustrating a hardware configuration of a conventional NFV system.

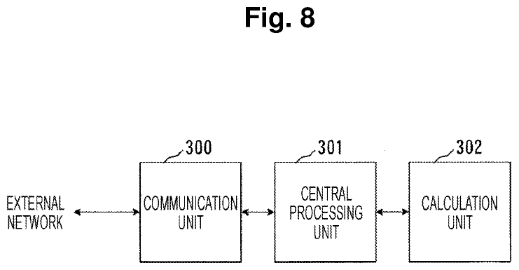

### DETAILED DESCRIPTION OF ILLUSTRATIVE EMBODIMENTS

### First Embodiment

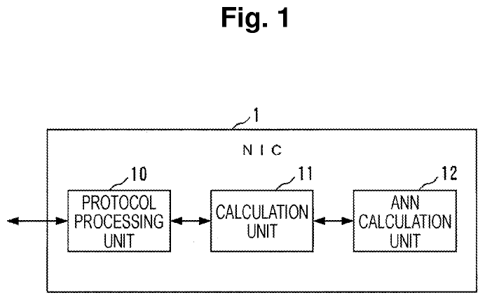

Hereinafter, embodiments of the present invention will be described with reference to the drawings. FIG. 1 is a block diagram illustrating a configuration of an NFV system according to a first embodiment of the present invention. The NFV system of the present embodiment includes an NIC 1. The NIC 1 includes a protocol processing unit 10, a calculation unit 11 (first calculation unit), and an ANN calculation unit 12 (second calculation unit). Each of the protocol processing unit 10, the calculation unit 11, and the ANN calculation unit 12 is implemented using an application specific integrated circuit (ASIC).

The protocol processing unit 10 performs protocol processing on a packet received from an external network. The calculation unit 11 implements NFV for performing predetermined processing on the packet received by the NIC 1. The ANN that performs part of the processing of the NFV is constructed by software by the ANN calculation unit 12. The ANN performs processing related to network operation management such as IDS and load distribution, for example.

In the present embodiment, all processing of NFV is performed by the calculation unit 11 and the ANN calculation unit 12. Since data transfer is performed in the NIC 1 between the protocol processing unit 10, the calculation unit 11, and the ANN calculation unit 12, a conventional delay does not occur.

In addition, the processing band of the ANN is not limited by the throughput of the bus between the CPU and the GPU as in the related art. In addition, in the present embodiment, since a general-purpose operating system (OS) is not used, a delay due to the OS does not occur. In the present embodiment, it is possible to reduce power consumption, initial cost, and management cost by eliminating devices such as a CPU and a GPU of a conventional NFV system.

### Second Embodiment

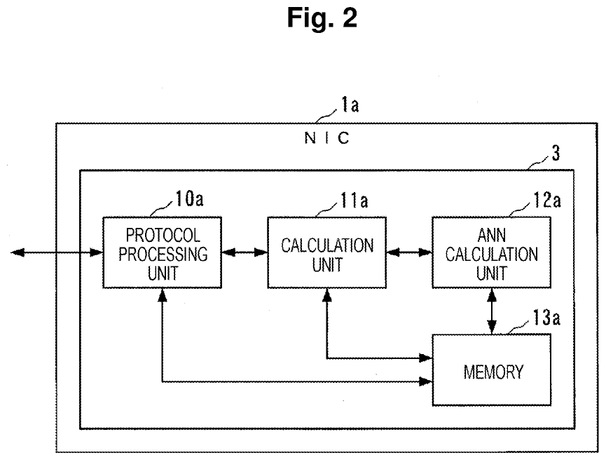

Next, a second embodiment of the present invention will be described. FIG. 2 is a block diagram illustrating a configuration of an NFV system according to the second embodiment of the present invention. The NFV system of the present embodiment includes an NIC 1a. The NIC 1a includes a protocol processing unit 10a, a calculation unit 11a, an ANN calculation unit 12a, and a memory 13a.

The operation of the protocol processing unit 10a is the same as that of the protocol processing unit 10 of the first embodiment. The operation of the calculation unit 11a is the same as that of the calculation unit 11 of the first embodiment. The operation of the ANN calculation unit 12a is the same as that of the ANN calculation unit 12 of the first embodiment.

In the present embodiment, the protocol processing unit 10a, the calculation unit 11a, the ANN calculation unit 12a, and the memory 13a are implemented by a programmable logic device 3 such as a field programmable gateway (FPGA) or a course grained reconfigurable array (CGRA). Programs (circuit configuration data) of the protocol processing unit 10a, the calculation unit 11a, and the ANN calculation unit 12a are stored in the memory 13a.

Therefore, effects similar to those of the first embodiment can be obtained in the present embodiment. Furthermore, in the present embodiment, by using the programmable logic device 3, it is possible to change the operations of the protocol processing unit 10a, the calculation unit 11a, and the ANN calculation unit 12a. In the present embodiment, the NIC 1a can be mounted on one chip, and further reduction in delay and broader band can be achieved.

In the conventional system using the middlebox, it is necessary to stop the middlebox once, rewrite the program, and replace the hardware. On the other hand, in the present embodiment, by rewriting the program of the memory 13a, the operations of the protocol processing unit 10a, the calculation unit 11a, and the ANN calculation unit 12a can be changed while the power of the NIC 1a is on.

### Third Embodiment

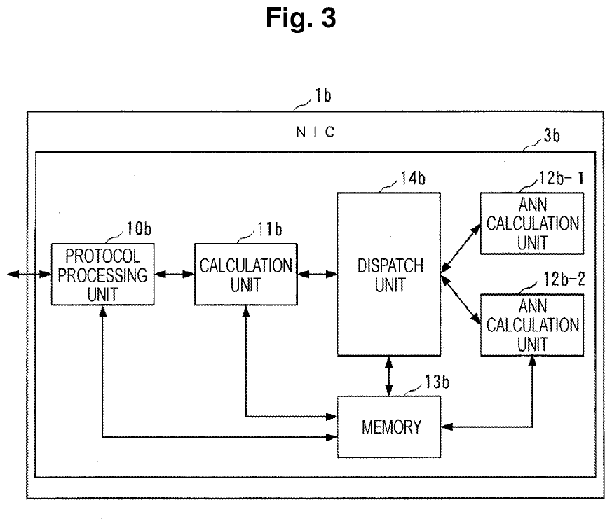

Next, a third embodiment of the present invention will be described. FIG. 3 is a block diagram illustrating a configuration of an NFV system according to the third embodiment of the present invention. The NFV system of the present embodiment includes an NIC 1b. The NIC 1b includes a protocol processing unit 10b, a calculation unit 1b, a plurality of ANN calculation units 12b-1 and 12b-2, a memory 13b, and a dispatch unit 14b.

The operation of the protocol processing unit 10b is the same as that of the protocol processing unit 10 of the first embodiment. The operation of the calculation unit 1b is the same as that of the calculation unit 11 of the first embodiment. The ANN calculation units 12b-1 and 12b-2 perform processing of the same ANN as the ANN calculation unit 12 of the first embodiment alone or in combination.

The dispatch unit 14b monitors the operating statuses of the ANN calculation units 12b-1 and 12b-2, divides the processing of the ANN according to the operating statuses of the ANN calculation units 12b-1 and 12b-2, and allocates the divided processing to the ANN calculation units 12b-1 and 12b-2 to achieve efficient processing.

The ANN calculation units 12b-1 and 12b-2 execute processing of the divided ANNs in parallel. Since the dispatch unit 14b monitors the operating statuses of the ANN calculation units 12b-1 and 12b-2, even if parallel processing is more efficient, processing may be performed by one ANN calculation unit in a case where there is only one vacant ANN calculation unit.

In the example of FIG. 3, two ANN calculation units 12b-1 and 12b-2 are provided, but three or more ANN calculation units may be provided.

In the present embodiment, the protocol processing unit 10b, the calculation unit 11b, the ANN calculation units 12b-1 and 12b-2, the memory 13b, and the dispatch unit 14b are implemented by a programmable logic device 3b such as an FPGA or a CGRA. Programs (circuit configuration data) of the protocol processing unit 10b, the calculation unit 11b, the ANN calculation units 12b-1 and 12b-2, and the dispatch unit 14b are stored in the memory 13b.

Therefore, effects similar to those of the second embodiment can be obtained in the present embodiment. In the present embodiment, the processing of the ANN is divided and executed in parallel, which can improve the efficiency of the processing. In addition, in the present embodiment, the dispatch unit 14b monitors the operating statuses of the ANN calculation units 12b-1 and 12b-2, and therefore the optimal timing of job input can be determined, and efficient operation can be performed.

### Fourth Embodiment

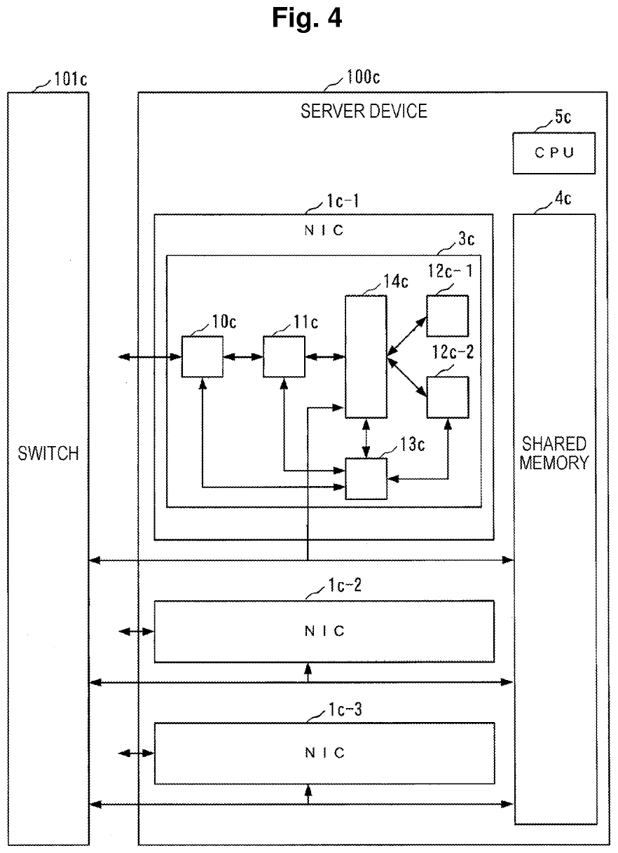

Next, a fourth embodiment of the present invention will be described. FIG. 4 is a block diagram illustrating a configuration of an NFV system according to the fourth embodiment of the present invention. The NFV system of the present embodiment includes a server device 100c and a switch 101c. The server device 100c includes a plurality of NICs 1c-1, 1c-2, and 1c-3, a shared memory 4c, and a CPU 5c.

The NIC 1c-1 includes a protocol processing unit 10c, a calculation unit 11c, a plurality of ANN calculation units 12c-1 and 12c-2, a memory 13c, and a dispatch unit 14c. The configurations of the NICs 1c-2 and 1c-3 are the same as that of the NIC 1c-1.

The operation of the protocol processing unit 10c is the same as that of the protocol processing unit 10 of the first embodiment. The operation of the calculation unit 11c is the same as that of the calculation unit 11 of the first embodiment. The ANN calculation units 12c-1 and 12c-2 perform processing of the same ANN as the ANN calculation unit 12 according to the first embodiment alone or in combination.

Similarly to the third embodiment, the dispatch unit 14c monitors the operating statuses of the ANN calculation units 12c-1 and 12c-2, divides the processing of the ANN according to the operating statuses of the ANN calculation units 12c-1 and 12c-2, and allocates the divided processing to the ANN calculation units 12c-1 and 12c-2 to achieve efficient processing. A characteristic operation of the dispatch unit 14c different from that of the third embodiment will be described later.

In the example of FIG. 4, two ANN calculation units 12c-1 and 12c-2 are provided in one NIC, but three or more ANN calculation units may be provided.

In the present embodiment, the protocol processing unit 10c and the calculation unit 11c of each NIC, the ANN calculation units 12c-1 and 12c-2, the memory 13c, and the dispatch unit 14c are implemented by a programmable logic device 3c such as an FPGA or a CGRA. Programs (circuit configuration data) of the protocol processing unit 10c, the calculation unit 11c, the ANN calculation units 12c-1 and 12c-2, and the dispatch unit 14c are stored in the memory 13c.

The switch 101c connects the dispatch units 14c of the respective NICs via a network.

The shared memory 4c is a memory under control of the CPU 5c of the server device 100c, and is connected to the dispatch unit 14c of each NIC via an internal bus.

Hereinafter, a characteristic operation of the dispatch unit 14c of the present embodiment will be described. The dispatch unit 14c performs any one of the following processes (I) to (III) according to the configuration of the server device 100c.

(I) In a case where the dispatch units 14c of the respective NICs are connected by both the external network of the server device 100c and the internal bus of the server device 100c, each dispatch unit 14c always writes the state information of the subordinate ANN calculation units 12c-1 and 12c-2 connected to itself in the shared memory 4c. In addition, each dispatch unit 14c reads the state information of the ANN calculation units 12c-1 and 12c-2 written in the shared memory 4c by the dispatch unit 14c of another NIC.

When the ANN calculation units 12c-1 and 12c-2 under control are in the busy state, each dispatch unit 14c determines whether or not the processing of the ANN calculation units 12c-1 and 12c-2 in the busy state can be allocated to the ANN calculation units 12c-1 and 12c-2 of another NIC on the basis of the state information of the ANN calculation units 12c-1 and 12c-2 of another NIC.

Then, in a case where the dispatch unit 14c determines that the ANN calculation units 12c-1 and 12c-2 of another NIC can be allocated, the dispatch unit 14c of the NIC is requested via the external network and the switch 101c to execute the processing of the ANN calculation units 12c-1 and 12c-2 in the busy state.

The dispatch unit 14c of the NIC that has received the request allocates the requested processing to the ANN calculation units 12c-1 and 12c-2 under control. The processing result of the ANN is returned to the dispatch unit 14c of the NIC as the request source via the external network and the switch 101c.

(II) In a case where the dispatch units 14c of the respective NICs are connected only by the external network of the server device 100c, each dispatch unit 14c always writes the state information of the subordinate ANN calculation units 12c-1 and 12c-2 connected to itself in the memory 13c connected to itself. In addition, each dispatch unit 14c reads the state information of the ANN calculation units 12c-1 and 12c-2 written in the memory 13c in the NIC by the dispatch unit 14c of another NIC via the external network and the switch 101c.

When the ANN calculation units 12c-1 and 12c-2 under control are in the busy state, each dispatch unit 14c determines whether or not the processing of the ANN calculation units 12c-1 and 12c-2 in the busy state can be allocated to the ANN calculation units 12c-1 and 12c-2 of another NIC on the basis of the state information of the ANN calculation units 12c-1 and 12c-2 of another NIC.

Then, in a case where the dispatch unit 14c determines that the ANN calculation units 12c-1 and 12c-2 of another NIC can be allocated, the dispatch unit 14c of the NIC is requested via the external network and the switch 101c to execute the processing of the ANN calculation units 12c-1 and 12c-2 in the busy state.

The dispatch unit 14c of the NIC that has received the request allocates the requested processing to the ANN calculation units 12c-1 and 12c-2 under control. The processing result of the ANN is returned to the dispatch unit 14c of the NIC as the request source via the external network and the switch 101c.

(III) In a case where the dispatch units 14c of the respective NIC are connected only by the internal bus of the server device 100c, each dispatch unit 14c always writes the state information of the ANN calculation units 12c-1 and 12c-2 under control in the shared memory 4c. In addition, each dispatch unit 14c reads the state information of the ANN calculation units 12c-1 and 12c-2 written in the shared memory 4c by the dispatch unit 14c of another NIC.

When the ANN calculation units 12c-1 and 12c-2 under control are in the busy state, each dispatch unit 14c determines whether or not the processing of the ANN calculation units 12c-1 and 12c-2 in the busy state can be allocated to the ANN calculation units 12c-1 and 12c-2 of another NIC on the basis of the state information of the ANN calculation units 12c-1 and 12c-2 of another NIC.

Then, in a case where the dispatch unit 14c determines that the ANN calculation units 12c-1 and 12c-2 of another NIC can be allocated, the dispatch unit 14c of the NIC is requested via the internal bus to execute the processing of the ANN calculation units 12c-1 and 12c-2 in the busy state.

The dispatch unit 14c of the NIC that has received the request allocates the requested processing to the ANN calculation units 12c-1 and 12c-2 under control. The processing result of the ANN is returned to the dispatch unit 14c of the NIC as the request source via the internal bus.

Therefore, effects similar to those of the third embodiment can be obtained in the present embodiment. Furthermore, in the present embodiment, the execution efficiency of the processing of the ANN can be improved, and the utilization efficiency of the entire system can be improved.

### Fifth Embodiment

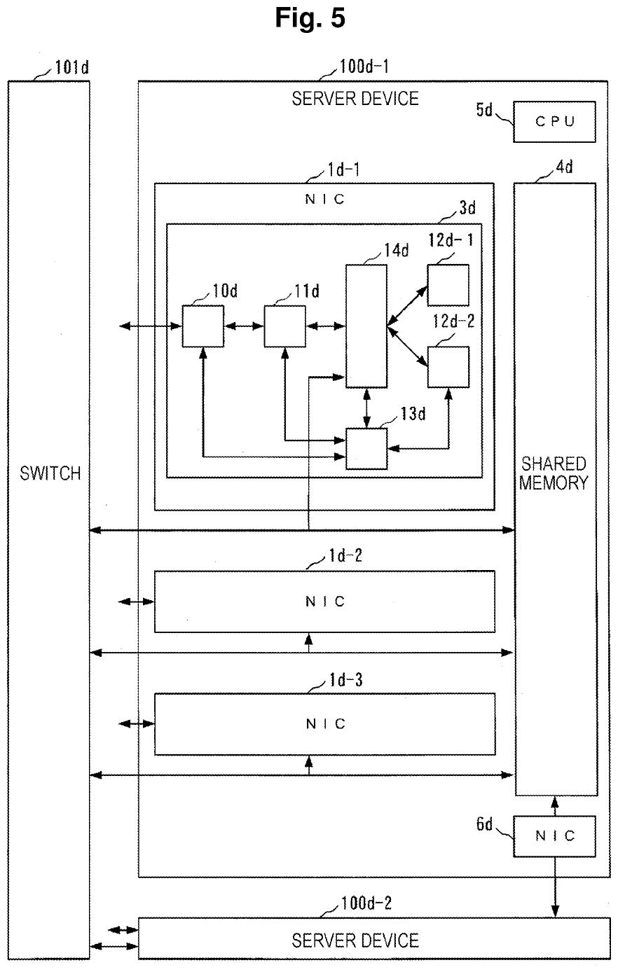

Next, a fifth embodiment of the present invention will be described. FIG. 5 is a block diagram illustrating a configuration of an NFV system according to the fifth embodiment of the present invention. The NFV system of the present embodiment includes a plurality of server devices 100d-1 and 100d-2 and a switch 101d. The server device 100d-1 includes a plurality of NICs 1d-1, 1d-2, and 1d-3, a shared memory 4d, a CPU 5d, and an NIC 6d. The configuration of the server device 100d-2 is the same as that of the server device 100d-1.

The NIC 1d-1 includes a protocol processing unit 10d, a calculation unit 11d, a plurality of ANN calculation units 12d-1 and 12d-2, a memory 13d, and a dispatch unit 14d. The configurations of the NICs 1d-2 and 1d-3 are the same as that of the NIC 1d-1.

The operation of the protocol processing unit 10d is the same as that of the protocol processing unit 10 of the first embodiment. The operation of the calculation unit 11d is the same as that of the calculation unit 11 of the first embodiment. The ANN calculation units 12d-1 and 12d-2 perform processing of the same ANN as the ANN calculation unit 12 according to the first embodiment alone or in combination.

Similarly to the fourth embodiment, the dispatch unit 14d monitors the operating statuses of the ANN calculation units 12d-1 and 12d-2, divides the processing of the ANN according to the operating statuses of the ANN calculation units 12d-1 and 12d-2, and allocates the divided processing to the ANN calculation units 12d-1 and 12d-2 to achieve efficient processing. A characteristic operation of the dispatch unit 14d different from that of the third embodiment will be described later.

In the example of FIG. 5, two ANN calculation units 12d-1 and 12d-2 are provided in one NIC, but three or more ANN calculation units may be provided.

In the present embodiment, the protocol processing unit 10d and the calculation unit 11d of each NIC, the ANN calculation units 12d-1 and 12d-2, the memory 13d, and the dispatch unit 14d are implemented by a programmable logic device 3d such as an FPGA or a dGRA. Programs (circuit configuration data) of the protocol processing unit 10d, the calculation unit 11d, the ANN calculation units 12d-1 and 12d-2, and the dispatch unit 14d are stored in the memory 13d.

The switch 101d connects the dispatch units 14d of the respective NICs of the server devices 100d-1 and 100d-2 via a network.

The shared memory 4d is connected to the dispatch unit 14d of each NIC in the same server device via an internal bus.

The NIC 6d is an NIC for remote direct memory access (RDMA). By using the NIC 6d, data in the shared memory 4d can be shared between the server devices while benefiting from conventional RDMA.

Hereinafter, a characteristic operation of the dispatch unit 14d of the present embodiment will be described. The dispatch unit 14d performs any one of the following processes (IV) to (VI) according to the configurations of the server devices 100d-1 and 100d-2.

(IV) In a case where the dispatch units 14d of the respective NICs of the server devices 100d-1 and 100d-2 are connected to each other by both the external network and the internal bus via the NIC 6d, each dispatch unit 14d always writes the state information of the subordinate ANN calculation units 12d-1 and 12d-2 connected to itself in the shared memory 4d connected to itself. In addition, each dispatch unit 14d reads the state information of the ANN calculation units 12d-1 and 12d-2 written in the shared memory 4d by the dispatch unit 14d of another NIC.

The NIC 6d of each of the server devices 100d-1 and 100d-2 transfers information recorded in the shared memory 4d in the same server device to the shared memory 4d of another server device. In this way, coherence of the information of the shared memory 4d is maintained between the server devices 100d-1 and 100d-2. That is, each dispatch unit 14d can read not only the state information of the ANN calculation units 12d-1 and 12d-2 of another NIC in the same server device but also the state information of the ANN calculation units 12d-1 and 12d-2 of the NIC in another server device from the shared memory 4d.

When the ANN calculation units 12d-1 and 12d-2 under control are in the busy state, each dispatch unit 14d determines whether or not the processing of the ANN calculation units 12d-1 and 12d-2 in the busy state can be allocated to the ANN calculation units 12d-1 and 12d-2 of another NIC on the basis of the state information of the ANN calculation units 12d-1 and 12d-2 of another NIC.

Then, in a case where the dispatch unit 14d determines that the ANN calculation units 12d-1 and 12d-2 of another NIC can be allocated, the dispatch unit 14d of the NIC is requested via the external network and the switch 101d to execute the processing of the ANN calculation units 12d-1 and 12d-2 in the busy state.

The dispatch unit 14d of the NIC that has received the request allocates the requested processing to the ANN calculation units 12d-1 and 12d-2 under control. The processing result of the ANN is returned to the dispatch unit 14d of the NIC as the request source via the external network and the switch 101d. Unlike the fourth embodiment, in the present embodiment, it is possible to request the dispatch unit 14d of another server device to perform processing.

(V) In a case where the dispatch units 14d of the respective NICs of the server devices 100d-1 and 100d-2 are connected to each other only by the external network, each dispatch unit 14d always writes the state information of the subordinate ANN calculation units 12d-1 and 12d-2 connected to itself in the memory 13d connected to itself.

In addition, each dispatch unit 14d reads the state information of the ANN calculation units 12d-1 and 12d-2 written in the memory 13d in the NIC by the dispatch unit 14d of another NIC via the external network and the switch 101d. Thus, each dispatch unit 14d can read not only the state information of the ANN calculation units 12d-1 and 12d-2 of another NIC in the same server device but also the state information of the ANN calculation units 12d-1 and 12d-2 of the NIC in another server device.

When the ANN calculation units 12d-1 and 12d-2 under control are in the busy state, each dispatch unit 14d determines whether or not the processing of the ANN calculation units 12d-1 and 12d-2 in the busy state can be allocated to the ANN calculation units 12d-1 and 12d-2 of another NIC on the basis of the state information of the ANN calculation units 12d-1 and 12d-2 of another NIC.

Then, in a case where the dispatch unit 14d determines that the ANN calculation units 12d-1 and 12d-2 of another NIC can be allocated, the dispatch unit 14d of the NIC is requested via the external network and the switch 101d to execute the processing of the ANN calculation units 12d-1 and 12d-2 in the busy state.

The dispatch unit 14d of the NIC that has received the request allocates the requested processing to the ANN calculation units 12d-1 and 12d-2 under control. The processing result of the ANN is returned to the dispatch unit 14d of the NIC as the request source via the external network and the switch 101d. Unlike the fourth embodiment, in the present embodiment, it is possible to request the dispatch unit 14d of another server device to perform processing.

(VI) In a case where the dispatch units 14d of the respective NICs of the server device 100d-1 and 100d-2 are connected only by the internal bus of the server devices 100d-1 and 100d-2, each dispatch unit 14d always writes the state information of the subordinate ANN calculation units 12d-1 and 12d-2 connected to itself in the shared memory 4d connected to itself. In addition, each dispatch unit 14d reads the state information of the ANN calculation units 12d-1 and 12d-2 written in the shared memory 4d by the dispatch unit 14d of another NIC.

The NIC 6d of each of the server devices 100d-1 and 100d-2 transfers information recorded in the shared memory 4d in the same server device to the shared memory 4d of another server device. In this way, the coherence of the information of the shared memory 4d is maintained between the server devices 100d-1 and 100d-2.

When the ANN calculation units 12d-1 and 12d-2 under control are in the busy state, each dispatch unit 14d determines whether or not the processing of the ANN calculation units 12d-1 and 12d-2 in the busy state can be allocated to the ANN calculation units 12d-1 and 12d-2 of another NIC on the basis of the state information of the ANN calculation units 12d-1 and 12d-2 of another NIC.

Then, in a case where the dispatch unit 14d determines that the ANN calculation units 12d-1 and 12d-2 of another NIC can be allocated, the dispatch unit 14d of the NIC is requested via the internal bus to execute the processing of the ANN calculation units 12d-1 and 12d-2 in the busy state. In a case where the dispatch unit 14d as the request destination is in another server device, the dispatch unit 14d makes a request via the internal bus and the NIC 6d.

The dispatch unit 14d of the NIC that has received the request allocates the requested processing to the ANN calculation units 12d-1 and 12d-2 under control. The processing result of the ANN is returned to the dispatch unit 14d of the NIC as the request source via the internal bus. The dispatch unit 14d of the NIC that has received the request returns the processing result via the internal bus and the NIC 6d in a case where the dispatch unit 14d as the request source is in another server device.

Therefore, effects similar to those of the fourth embodiment can be obtained in the present embodiment. Furthermore, in the present embodiment, the execution efficiency of the processing of the ANN can be improved, and the utilization efficiency of the entire system can be improved.

### Sixth Embodiment

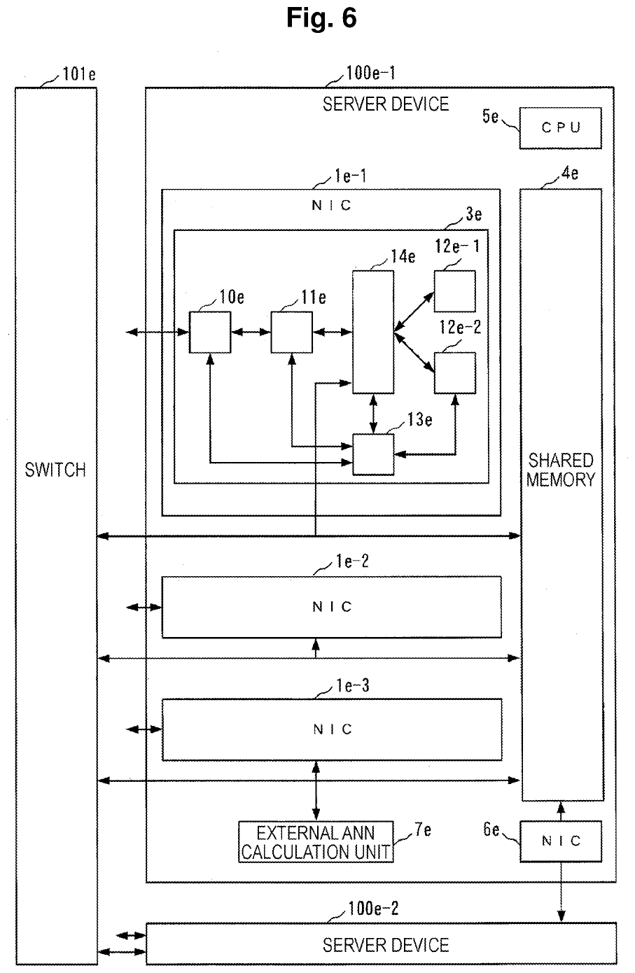

Next, a sixth embodiment of the present invention will be described. FIG. 6 is a block diagram illustrating a configuration of an NFV system according to the sixth embodiment of the present invention. The NFV system of the present embodiment includes a plurality of server devices 100e-1 and 100e-2 and a switch 101e. The server device 100e-1 includes a plurality of NIC 1e-1, 1e-2, and 1e-3, a shared memory 4e, a CPU 5e, an NIC 6e, and an external ANN calculation unit 7e. The configuration of the server device 100e-2 is the same as that of the server device 100e-1.

The NIC 1e-1 includes a protocol processing unit 10e, a calculation unit 11e, a plurality of ANN calculation units 12e-1 and 12e-2, a memory 13e, and a dispatch unit 14e. The configurations of the NICs 1e-2 and 1e-3 are the same as that of the NIC 1e-1.

The operation of the protocol processing unit 10e is the same as that of the protocol processing unit 10 of the first embodiment. The operation of the calculation unit 11e is the same as that of the calculation unit 11 of the first embodiment. The ANN calculation units 12e-1 and 12e-2 perform processing of the same ANN as the ANN calculation unit 12 according to the first embodiment alone or in combination.

Similarly to the fifth embodiment, the dispatch unit 14e monitors the operating statuses of the ANN calculation units 12e-1 and 12e-2, divides the processing of the ANN according to the operating statuses of the ANN calculation units 12e-1 and 12e-2, and allocates the divided processing to the ANN calculation units 12e-1 and 12e-2 to achieve efficient processing. A characteristic operation of the dispatch unit 14e different from that of the fifth embodiment will be described later.

In the example of FIG. 5, two ANN calculation units 12e-1 and 12e-2 are provided in one NIC, but three or more ANN calculation units may be provided.

In the present embodiment, the protocol processing unit 10e and the calculation unit 11e of each NIC, the ANN calculation units 12e-1 and 12e-2, the memory 13e, and the dispatch unit 14e are implemented by a programmable logic device 3e such as an FPGA or an eGRA. Programs (circuit configuration data) of the protocol processing unit 10e, the calculation unit 11e, the ANN calculation units 12e-1 and 12e-2, and the dispatch unit 14e are stored in the memory 13e.

The switch 101e connects the dispatch units 14e of the respective NICs of the server devices 100e-1 and 100e-2 via a network.

The shared memory 4e is connected to the dispatch unit 14e of each NIC in the same server device via an internal bus.

The NIC 6e is an NIC for RDMA.

Hereinafter, a characteristic operation of the dispatch unit 14e of the present embodiment will be described. The operation of the dispatch unit 14e is similar to that of the dispatch unit 14d of the fifth embodiment. The difference from the fifth embodiment is that the dispatch unit 14e requests the external ANN calculation unit 7e to process the ANN that requires a large calculation amount that cannot be processed by the programmable logic device 3e. The external ANN calculation unit 7e is implemented using a GPU.

Therefore, effects similar to those of the fifth embodiment can be obtained in the present embodiment. Furthermore, in the present embodiment, by executing part of the processing that requires a large calculation amount using the external ANN calculation unit 7e, the execution efficiency of the processing of the ANN can be improved.

### Seventh Embodiment

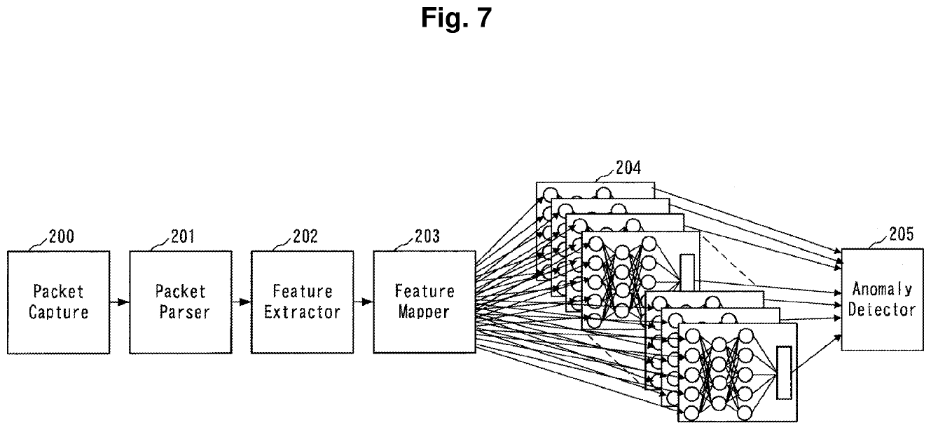

Next, a seventh embodiment of the present invention will be described. FIG. 7 is a block diagram illustrating a configuration of an NFV system disclosed in Non Patent Literature 1. The NFV system in FIG. 7 includes a packet capture 200, a packet parser 201, a feature extractor 202, a feature mapper 203, an ensemble layer 204, and an anomaly detector 205.

Using the NFV system described in the sixth embodiment, the packet capture 200 is implemented by the protocol processing unit 10e, the packet parser 201 is implemented by the calculation unit 11e, the feature mapper 203 is implemented by the dispatch unit 14e, and the feature extractor 202, the ensemble layer 204, and the anomaly detector 205 are implemented by the ANN calculation units 12e-1 and 12e-2 and the external ANN calculation unit 7e.

Thus, in the present embodiment, by allocating the functions described in the sixth embodiment to the NFV system disclosed in Non Patent Literature 1, the ANN calculation unit can be allocated for each ensemble layer, and the system can be physically expanded.

Even if the ensemble layer of the ANN is increased by physically mapping the ANN, it is possible to cope with the increase by physically increasing the number of NICs. In the related art, the load on the server increases, and the bandwidth and the delay performance deteriorate.

### INDUSTRIAL APPLICABILITY

Embodiments of the present invention can be applied to an NFV system.

### REFERENCE SIGNS LIST

1, 1a, 1b, 1c-1, 1c-2, 1c-3, 1d-1, 1d-2, 1d-3, 1e-1, 1e-2, 1e-3, 6d NIC
3, 3b, 3c, 3d, 3e Programmable logic device
4c, 4d, 4e Shared memory
5c, 5d, 5e CPU
7e External ANN calculation unit
10, 10a, 10b, 10c, 10d, 10e Protocol processing unit
11, 11a, 11b, 11c, 11d, 11e Calculation unit
12, 12a, 12b-1, 12b-2, 12c-1, 12c-2, 12d-1, 12d-2, 12e-1, 12e-2 ANN calculation unit
13a, 13b, 13c, 13d, 13e Memory
14b, 14c, 14d, 14e Dispatch unit
100c, 100d-1, 100d-2, 100e-1, 100e-2 Server device
101c, 101dc, 101e Switch

1-8. (canceled)

9. An network function virtualization (NFV) system comprising a first network interface card (NIC), wherein the first NIC includes:
a protocol processor configured to receive a packet from an external network;
a first calculator configured to implement NFV to perform predetermined processing on the packet; and
a second calculator configured to perform processing with an artificial neural network (ANN) in implementing the NFV, wherein the protocol processor, the first calculator, and the second calculator are each mounted on the first NIC.

10. The NFV system according to claim 9, wherein the protocol processor, the first calculator, and the second calculator include a programmable logic device.

11. The NFV system according to claim 9, wherein:
a plurality of second calculators are provided in the first NIC, each of the plurality of second calculators being configured to perform processing with the ANN in implementing the NFV; and
the first NIC further includes a dispatcher configured to monitor operating statuses of the plurality of second calculators, divide processing of the ANN according to the operating statuses of the plurality of second calculators, and allocate the processing of the ANN to the plurality of second calculators.

12. The NFV system according to claim 11, wherein the protocol processor, the first calculator, the second calculator, and the dispatcher include a programmable logic device.

13. The NFV system according to claim 11, wherein:
a plurality of first NICs are provided in a server device, wherein the plurality of first NICs comprises the first NIC;
the server device further includes a shared memory; and
a dispatcher of each of the plurality of first NICs is configured to:
write state information of a second calculator under control in the shared memory;
determine whether or not processing of the second calculator under control and in a busy state is allocatable to a second calculator of another one of the plurality of first NICs based on the state information recorded in the shared memory when the second calculator under control is in the busy state; and
request a dispatcher of one of the plurality of first NICs to which the processing has been determined to be allocatable to execute the processing of the second calculator under control and in the busy state.

14. The NFV system according to claim 12, wherein:
a plurality of first NICs are provided in a server device, wherein the plurality of first NICs comprises the first NIC;
a protocol processor, a first calculator, a second calculator, and a dispatcher of each of the plurality of first NICs include a programmable logic device; and
a dispatcher of each of the plurality of first NICs is configured to:
writes state information of a second calculator under control in a memory of a respective programmable logic device in a same first NIC as the dispatcher;
read state information recorded in a memory of a programmable logic device of another first NIC of the plurality of first NICs via a network when the second calculator under control is in a busy state;
determine whether or not processing of the second calculator in the busy state is allocatable to a second calculator of another first NIC of the plurality of first NICs; and
request a dispatcher of the another first NIC to which the processing has been determined to be allocatable to execute the processing of the second calculator under control and in the busy state.

15. The NFV system according to claim 11, wherein
a plurality of first NICs are provided in each of a plurality of server devices, wherein the plurality of first NICs comprises the first NIC;
each of the plurality of server devices includes the plurality of first NICs, a shared memory, and a second NIC for remote direct memory access (RDMA);
a dispatcher of each of the plurality of first NICs is configured to:
write state information of a second calculator under control in the shared memory in a same server device as the dispatcher;
determine whether or not processing of the second calculator under control and in a busy state is allocatable to a second calculator of another one of the plurality of first NICs based on the state information recorded in the shared memory when the second calculator under control is in the busy state; and
request a dispatcher of one of the plurality of first NICs to which the processing has been determined to be allocatable to execute the processing of the second calculator under control and in the busy state; and
a second NIC of each of the plurality of server devices is configured to transfer information recorded in a shared memory in a same server device as the second NIC to a shared memory of another server device.

16. The NFV system according to claim 12, wherein
a plurality of first NICs are provided in each of a plurality of server devices, wherein the plurality of first NICs comprises the first NIC;
a protocol processor, a first calculator, a second calculator, and a dispatcher of each of the plurality of first NICs include a programmable logic device; and
a dispatcher of each of the plurality of first NICs is configured to:
writes state information of a second calculator under control in a memory of a respective programmable logic device in a same first NIC as the dispatcher;
read state information recorded in a memory of a programmable logic device of another first NIC of the plurality of first NICs via a network when the second calculator under control is in a busy state;
determine whether or not processing of the second calculator in the busy state is allocable to a second calculator of another first NIC of the plurality of first NICs; and
request a dispatcher of the another first NIC to which the processing has been determined to be allocatable to execute the processing of the second calculator under control and in the busy state.

17. An network function virtualization (NFV) method comprising:
receiving, by a protocol processor, a packet from an external network;
implementing, by a first calculator, NFV to perform predetermined processing on the packet; and
performing, by a second calculator, processing with an artificial neural network (ANN) in implementing the NFV, wherein the protocol processor, the first calculator, and the second calculator are each mounted on a first network interface card (NIC).

18. The NFV method according to claim 17, wherein the protocol processor, the first calculator, and the second calculator include a programmable logic device.

19. The NFV method according to claim 17, wherein:
a plurality of second calculators are provided in the first NIC, each of the plurality of second calculators being configured to perform processing with the ANN in implementing the NFV; and
the method further includes:
monitoring, by a dispatcher, operating statuses of the plurality of second calculators;
dividing processing of the ANN according to the operating statuses of the plurality of second calculators; and
allocating the processing of the ANN to the plurality of second calculators.

20. The NFV method according to claim 19, wherein the protocol processor, the first calculator, the second calculator, and the dispatcher include a programmable logic device.
